(19) United States
(12) Patent Application Publication
(10) Pub. No.: US 2023/0320464 A1
(43) Pub. Date: Oct. 12, 2023

(54) FASTENER PART

(71) Applicant: GOTTLIEB BINDER GMBH & CO. KG, Holzgerlingen (DE)

(72) Inventor: Lars HEEPE, Tübingen (DE)

(21) Appl. No.: 18/013,606

(22) PCT Filed: Nov. 19, 2021
(86) PCT No.: PCT/EP2021/082285

§ 371 Date: Dec. 29, 2022

(30) Foreign Application Priority Data
Dec. 11, 2020 (DE) 10 2020 007 585.1

(51) Int. Cl. A44B 18/00; B29C 43/46; B29C 43/22

(52) U.S. Cl. CPC A44B 18/0065; A44B 18/0049; B29C 43/46; B29C 43/222; B29C 2043/461

(57) ABSTRACT

A fastener part consisting of at least one planar substrate part (10), on one side of which a plurality of mushroom-head-like fastener elements are arranged, each of which, as an integral part of the substrate part (10), has a solid stem part (17) formed in the manner of a rotational hyperboloid and extending along a longitudinal axis, wherein to the free end of said stem part (17) a head part (16) adjoins, the edge regions of which form hooking possibilities and project at least partially beyond the stem part (17), and wherein said head part (16) has a crater-like depression (20) on its upper side, characterized in that a plurality of further crater-like depressions (23) is incorporated into the further side (22) of the substrate part (10), opposite to the fastener elements, in that both crater-like depressions (20, 23) of at least some of the fastener elements extend concentrically or mainly concentrically to the longitudinal axis of the respective assigned stem part (17), and in that the respective further crater-like depression (23) has a maximum crater depth ranging between 30 to 60%, preferably 50%, of the thickness of the substrate part (10).

The invention relates to a fastener part consisting of at least one planar substrate part, on one side of which a plurality of mushroom-head-like fastener elements are disposed in accordance with the preamble of patent claim 1.

DE 100 39 937 A1 describes a method for the manufacture of such fastener parts and touch fastener parts, respectively. The known touch fastener part is provided with a plurality of hooking means integrally connected to a substrate and symmetrically structured, wherein the hooking means are each in the form of a stem part provided with a head part each, wherein a moldable material is routed to a molding zone between a compression tool and a forming tool to perform the manufacturing process. Because in the known solution, at least when viewed in a longitudinal section of the respective mold cavity, the opposing boundary walls are provided end-to-end with a convex path, a steady transition is achieved between the cross-sectional shapes of the stem part and the head part for one hooking means of the substrate each, permitting a smooth demolding process.

Earlier fastener part solutions having a largely straight stem part are the subject matter of further publications, such as DE 196 46 318 A1.

Starting from this prior art, the invention addresses the problem of further improving the known solutions to create a fastener part having increased functionality and extended areas of application.

A fastener part having the features of patent claim 1 in its entirety solves this problem. Because, in accordance with the characterizing part of claim 1, a plurality of further crater-like depressions is introduced on the further side of the substrate part, opposite to the fastener elements, wherein both crater-like depressions of at least some of the fastener elements extend concentrically or mainly concentrically to the longitudinal axis of the respective assigned stem part, and wherein the respective further crater-like depression has a maximum crater depth ranging between 30 to 60%, preferably 50%, of the thickness of the substrate part, an additional functionality compared to the otherwise flat sides of the substrate part is created, wherein said additional functionality also results in extended areas of application for such fastener parts.

First of all, the further crater-like depressions in the rear area of the substrate part result in a pronounced reduction in weight, wherein grammages (mass/unit area in g/m²) in the order of normal paper for copiers and printers can be achieved; i.e. values <80 g/m². Since fastener parts of the type in question are mass-produced goods and have to be shipped to their respective places of use (automotive industry, diaper industry, clothing industry, etc.), for instance, as rolls of thousands of square meters, transport costs can be reduced to a relevant extent in this way without impairing the technical properties of such fastener parts, which consist of forming an repeatedly detachable and closable touch fastener with a sling ware or loop ware of a third component, wherein said touch fastener is also known in technical terms as a Velcro® fastener, even among end consumers. The weight reduction due to the crater-like depression at the head also contributes to this effect.

The aforementioned further crater-like depressions in the substrate part not only serve to reduce weight, but also reduce the overall amount of plastic material required to produce a fastener part using known manufacturing processes (chill-roll process), which contributes to reducing costs and protecting the environment.

In addition, it has been shown that such substrate parts of fastener parts having further crater-like or dent-like depressions have a lower flexural rigidity than the known fastener parts, such as those produced by way of example according to the teaching of DE 100 39 937 A1. This plays a particularly important role in so-called “software” solutions, in which such fastener parts are used for incontinence diapers and baby diapers, respectively, the functionality of which is intended to offer increased comfort to the wearer due to their suppleness.

In addition, the respective further crater-like depressions also provide the option of forming collection spaces and reservoirs, respectively, for instance for holding adhesives that are required to be able to attach the respective fastener part to a third component at its place of use at a later date. For the known solutions, the fastener part always had to be more or less completely covered with an adhesive application layer on the rear of the substrate part, which on the one hand increases the quantities of adhesive required and thus also the total product costs, and on the other hand could also result in the unintentional detachment of the adhesive application layer, which is avoided with the present solution according to the invention, because the adhesive application is largely protected by the individual further crater-like depression. Furthermore, there is the improved option, as exemplified in DE 2004 058 257 B4, of superposing several film-like plastic sheets for the touch fastener part from the rear, wherein the outer substrate layer can be “hooked” to the inner substrate layer via the further crater-like depressions, achieving an improved adhesion of superposed film-like substrate sheets or substrate layers for a fastener product.

In the fastener part according to the invention, provision is made that the respective further crater-like depression has a maximum crater depth, which is between 30 to 60%, preferably 50% of the thickness of the substrate part. In particular, the selection of the wall thickness for the substrate part results in harmonious crater-like shapes of the respective further crater-like depression in the substrate part.

The respective further crater-like depression having its crater base and its remaining crater shape extends essentially concentrically to a stem part of the respective mushroom-head-like fastener element, which is projecting from the substrate part adjacent to and opposite from this depression and is integrally connected to the substrate part. Viewed in cross-section, a kind of bridge structure, on which the fastener element can rest, is created such that increased support forces result when viewed in load directions on the fastener element in longitudinal orientation to the assigned stem part, which improves the fastener characteristic of the fastener part. Preferably provision is made to provide a depression assigned to every fastener element and all fastener elements are of identical design, as are all depressions with respect to one another. In this way, a regular structure is achieved for the respective fastener part as a whole, with extensive symmetry along the longitudinal and transverse axes of the fastener part.

As explained, the new generation of fastener parts mentioned increase the functionality, as are the possible areas of application for fastener parts designed in this way having crater-like or dent-like depressions at the rear. The further crater-like depressions can be easily mechanically introduced into the substrate part from the outside, for instance by permitting the projections disposed on an additional molding roller to penetrate into the rear area of the still plasticized substrate part to introduce the further crater-like depressions there in the plastic material, while compressing it. Another manufacturing option is to displace the material in the rear area of the substrate part by means of a nozzle-like fluid application with high pressure (water, air, etc.), while simultaneously producing the aforementioned depressions. However, the manufacturing processes used in this way do not ultimately result in a reduction in the grammage for the respective fastener part, because the plastic material is basically only displaced and not removed from the fastener part itself. In contrast, the plastic material can be removed from the back of the substrate part using etching processes such as those used in micro-electroplating to create the respective further crater-like depression. By removing the plastic material, the grammage of the fastener part is reduced.

However, it is surprising to an average person skilled in the field of touch fastener closure technology that, with proper control of the manufacturing process, the further crater-like depressions, preferably opposite to the respective mushroom-head-like structures, in the substrate part can be created. For instance, a demolding process on a molding roller having cavities for stem parts and head parts can be controlled such that, when the closure material is extracted, resistance builds up in the respective cavities of the molding roller during demolding of the fastener part in such a way that the underlying plastic material is drawn in like a crater, so that the respective further crater-like or dent-like depressions in the substrate part at the rear are created quasi-automatically during the molding process. This is without parallel in the prior art.

In a preferred embodiment of the fastener part according to the invention, provision is made that the respective further crater-like depression, starting from the planar, further side of the substrate part, extends continuously from there without any protrusion to the crater base. Because no protruding crater rim is created during the manufacture of the fastener part, the further processability for the fastener part is also not impaired.

In a further preferred embodiment of the fastener part according to the invention, provision is made that the respective further crater-like depression, viewed idealized in a longitudinal cross section transitions, starting from the further side of the substrate part, from a convex into a concave course of curvature in the direction of the crater base. This results in a harmonic curvature in the form of a sine or cosine curve and low material stresses along the crater formation. It has proved particularly advantageous if the concave central curvature is not as strongly curved as the subsequent convex curve at the rim.

In a further preferred embodiment of the fastener part according to the invention, provision is made that the respective further crater-like depression, viewed in a longitudinal direction of the substrate part corresponding to the direction of manufacture, in turn viewed in longitudinal cross section, runs off more flatly on one side towards the further side of the substrate part than on the opposite cross-sectional side. This crater formation results from the molding roller during the demolding process for the respective fastener element, contributing to the smooth demolding process.

In a further preferred embodiment of the fastener part according to the invention, provision is made that the respective stem part of a fastener element at least at its foot-end transition point towards the substrate part forms the uniformly extending rotational body, wherein said transition point has a smaller curvature than the transition of the stem part to the head-end widening having the hooking points of the fastener element, and that the course of curvature at each point of the adjacent and opposing depressions has a smaller curvature than the curvature relating to the head-end course of curvature of the stem part. In this way, a compromise is created between the smooth demolding of the respective fastener element from the mold and the simultaneous formation of a depression for the matching respective further crater of the substrate part.

In a further preferred embodiment of the fastener part according to the invention, provision is made for the largest diameter of the further crater-like depression at the point of the expiring to the further side of the substrate part to be larger than the diameter of the stem part at any point between its foot end and its head end, preferably larger than the extension of the head part at its widest point. On the one hand, the respective head part provides a good hooking possibility, while at the same time providing good support owing to the bridge-like transition from the flat underside of the substrate part in the direction of the crater base.

The fastener part according to the invention is explained in more detail below, including explanations of its manufacture, on the basis of one embodiment. In the figures, in principle and not to scale,

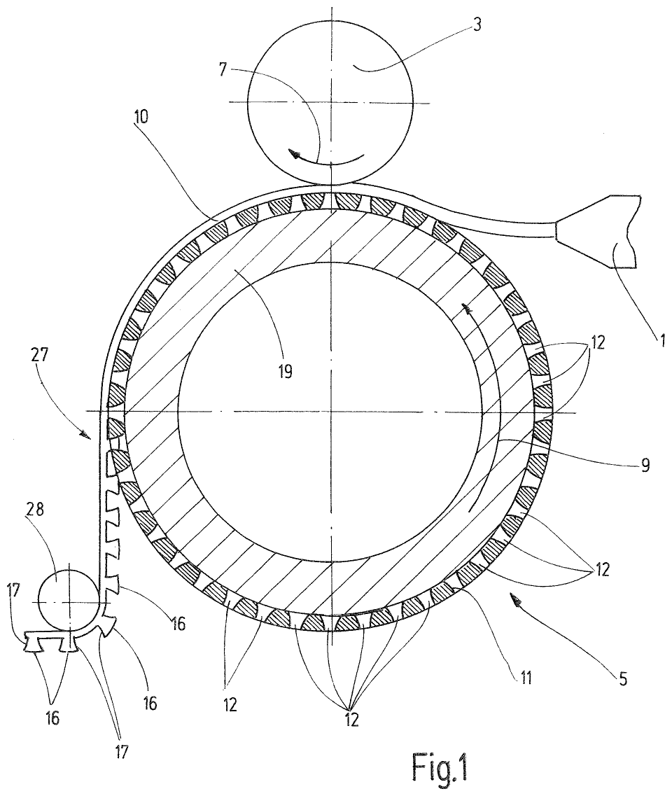

FIG. 1 shows a highly schematically simplified and partially sectioned side view of a device for performing a process for obtaining the fastener part according to the invention;

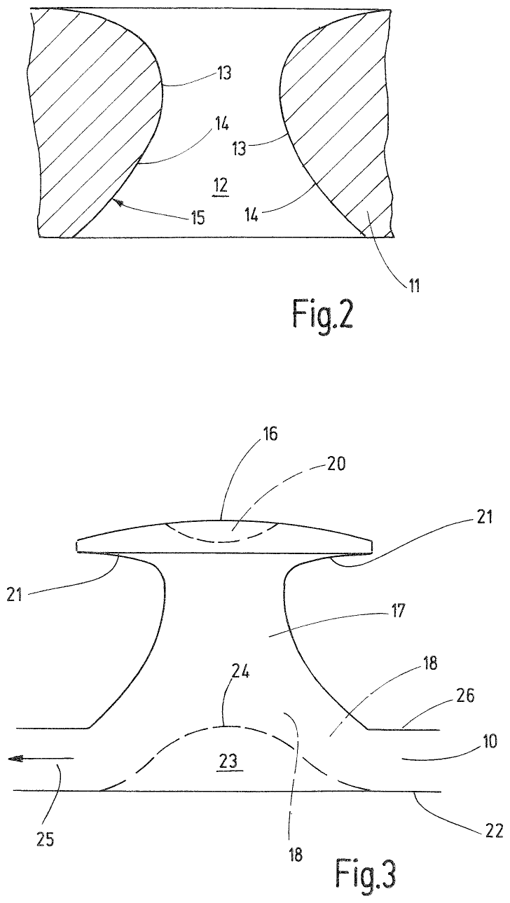

FIG. 2 shows a greatly enlarged longitudinal section through a mold cavity according to the representation of FIG. 1;

FIG. 3 shows a single fastener element as can be produced using the mold cavity according to FIG. 2;

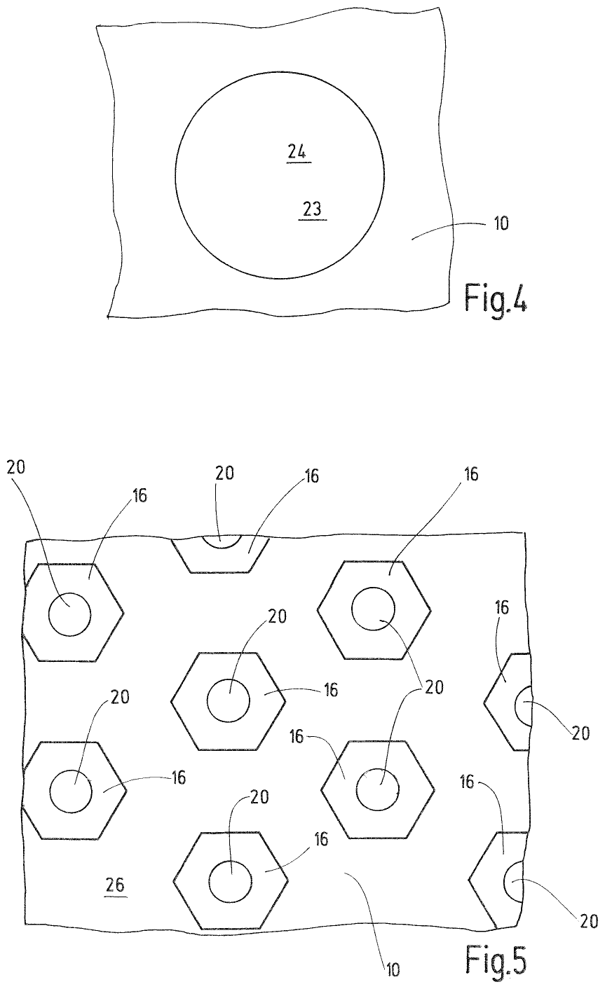

FIG. 4 shows a bottom view of the fastener part of FIG. 3;

FIG. 5 shows a top view of fastener elements, a single one of which is shown in FIG. 3.

FIG. 1 shows a schematic representation of parts of a device for performing a manufacturing process for obtaining a fastener part according to the invention. The apparatus has an extruder head 1 as a feed device for a plastic material, in particular a thermoplastic plastic material, which is in a plastic or liquid state and is fed as a strip to the gap between a pressure tool and a forming tool, wherein the width of said strip matches that of the fastener part and touch fastener part to be produced, respectively. The pressure tool is a pressure roller 3, whereas the forming tool is a molding roller designated as a whole by the numeral 5. Both rollers are driven in the directions of rotation indicated by arrows 7 and 9 in FIG. 1, forming a conveyor gap between them, through which the plastic strip is conveyed in the direction of transport, while at the same time the plastic strip is formed into the substrate part 10 of the fastener part in the gap as a shaping zone, and the shaping elements of the molding roller 5 shape the substrate part 10 on the side resting against the molding roller 5 as required to form fastener elements.

For this purpose, the molding roller 5 has on its circumference a screen ii having individual mold cavities 12. An example of such a mold cavity 12 is shown enlarged in FIG. 2. Furthermore, which is not shown in detail, the mold cavities 12 are regularly distributed across the outer circumference of the molding roller 5 having its screen ii, wherein their distribution and number can be selected freely.

FIG. 2 shows a longitudinal section through the respective mold cavity 12 used, wherein the boundary walls 13 facing each other in the longitudinal section, are provided end-to-end with a convex path 14. It goes without saying that, in view of the rotationally symmetrical structure of the mold cavity 12, the aforementioned two boundary walls 13 are basically only a part of a closing forming wall 15 delimited by the screen material ii of the molding roller 5. These mold cavities 12 in any case can be used to produce fastener elements in the form of a stem part 17 provided with a head part 16 each, wherein the head part 16, stem part 17 and opposite substrate part 10 merge integrally into one another. The forming device shown in FIG. 1 thus permits the fastener part according to the invention to be manufactured by a type of casting or extrusion process, which is also referred to in technical terms as the chill-roll manufacturing process.

As FIG. 2 further shows, the curvature of the respective path 14 in the direction of the head part 16 to be formed (as viewed in the direction of view of FIG. 2, upper area) is more pronounced than in the direction of a foot part 18, which is used to connect the stem part 17 to the substrate part 10 on the foot end or bottom end. It has proved to be particularly advantageous, also for forming the fastener part to be produced from the forming device, if the path 14 having the greater curvature is provided, as viewed from the longitudinal direction of the stem part 17 in the direction of the head part 16, above the center, preferably starting in the upper third.

Electroplating processes have proven effective for obtaining the mold cavities 12 mentioned having their rotationally symmetrical structure, in the form of a hyperboloid, in which a cylindrical mold cavity (not shown) is first coated with a coating material until the convex path 14 is produced. Furthermore, the convex path 14 could possibly also be generated from a screen or grid of solid material using a laser or etching process.

The single fastener element shown in FIG. 3, a plurality of which is located on a top face of the substrate part 10, can be obtained by the method described above with the inclusion of the manufacturing device according to FIG. 1. The symmetric structure results directly from the production in a mold cavity 12 according to FIG. 2. This fastener element can be geometrically very small in size, for instance having a height of only 0.4 mm, having a width of the closure head 16 in the order of 0.6 mm. The cross-section of the stem part 17 in this embodiment is approximately 0.25 mm. In contrast, the thickness of the substrate part 10 can be made even smaller, for instance having a thickness of 0.05 mm and 2 mm. The above mentioned size dimensions are only to be considered as a practical example; of course, different size ratios can be implemented as well.

Furthermore, according to the depiction of FIG. 5, a plurality of such fastener elements can be disposed on the substrate part 10. The hexagonal head shape of the head part 16, which is present in plan view, does not require any further finishing. Instead of the hexagonal shape of the respective head part 16, other head geometries can also be easily achieved by means of the shaping process described. Because the screen ii rests on a solid molding roller body 19, air is entrapped between the respective top face of the head and the outer circumferential side of the roller body 19, with the result that the air is displaced towards the center of the top face of the head, where it forms a crater-like, viewed from the outside, convex recess or depression 20, which helps to increase the rigidity toward the edges of the head part 16. As shown, the rim of the respective head part 16 protrudes beyond the stem part 17 at the rim end and thus forms a circumferential underhooking possibility 21 for the engagement of a head or loop material (not shown) of a matching fastener part to create a repeatedly openable and closable touch fastener (hook-and-loop fastener). If required, other head geometries can also be implemented.

As can further be seen from FIG. 2, a further crater-like depression 23 is provided on the further side 22, opposite to the fastener element, of the substrate part 10, wherein said further crater-like depression 23 is shown by way of example in a bottom view of the substrate part 10 in FIG. 4. It goes without saying that, with respect to the plurality of fastener elements standing on the substrate part 10, there is also a corresponding plurality of further crater-like depressions 23 in the substrate part 10. Otherwise, the top face 26 and the underside 22 of the substrate part 10 extend plane-parallel to each other.

The respective further crater-like depression 23 extends, starting from the plane further side 22 of the substrate part 10 continuously to the crater base 24 without any protrusions. The respective further depression 23 transitions, as viewed in a longitudinal section according to the representation shown in FIG. 3, starting from the further side 22 of the substrate part 10 from a convex to a concave course of curvature in the direction of the crater base 24. It has proved advantageous in terms of manufacturing technology if the concave curvature in the area of the crater base 24 is less strongly bent than the convex curvature. However, other trajectories and curvatures can also be selected depending on the process requirements; wherein in this case, the curvature trajectory is viewed from the inside of the substrate part 10.

Furthermore, viewed in the direction of view of FIG. 3, the respective crater-like depression 20 in a longitudinal direction 25 of the substrate part 10, which corresponds to the direction of manufacture, is more gently inclined in longitudinal cross-section viewed on one side (here, viewed in the direction of view of FIG. 3, the right side) than on the opposite cross-sectional side (viewed in the direction of view of FIG. 3, the left side). For the sake of simplicity, FIG. 3 does not show that preferably the respective further depression 23 has a maximum crater depth between 30 to 60%, preferably at about 50%, of the thickness of the substrate part 10. However, it is shown in particular in FIG. 4 that the respective further crater-like depression 23 having its crater base 24 and its remaining crater shape extends up to the crater rim essentially concentrically to the stem part 17 of the respective mushroom-head-like fastener element, which, as explained above, adjacent to and opposite from this further depression 23 is integrally connected to the substrate part 10 with a predeterminable degree of protrusion.

Preferably, such a further crater-like depression 23 is assigned to every fastener element, wherein all fastener elements preferably are of the same configuration, as are all further crater-like depressions 23 relative to one another. This also applies accordingly to the head-end convex recess 20 on the top face of the respective head part 16 of a fastener element. As further shown in particular in FIG. 3, the respective stem part 17 of a fastener element forms a uniformly extending rotational body at least at its foot-end transition point in the form of the foot part 18 towards the substrate part 10, wherein the transition point 18 has a smaller curvature than the transition of the stem part 17 to the head-end widening with the hooking points 21 of the fastener element. Furthermore, the course of curvature of the stem part 17 has a smaller curvature preferably at every location of the adjacent and opposite further crater-like depressions 23 than the curvature relating to the head-end course of curvature of the stem part 17, to achieve a particularly high hooking strength for the fastener part according to the invention in this way. In this context, it is advantageous if the deepest point of the convex crater-like depression 20 is disposed opposite from the deepest point of the further crater-like depression 23 at a predeterminable axial distance, formed by the length of the stem part 17.

As can be further seen from FIG. 3, the largest diameter of the further crater-like depression 23 at the point of exit to the further side 22 of the substrate part 10 is larger than the diameter of the stem part at any point between its foot end 18 and its head end 16, preferably the diameter of the further crater-like depression 23 is larger than the extent of the head part 16 at its widest point (not shown).

The preferred plastic materials for the fastener part are those having an elongation at break greater than 30%, and the size and thickness dimensions specified above are preferably measured using a DM2000 thickness gauge by the company Wolff-Messtechnik. In addition to the usual plastic materials for manufacturing such fastener parts, biodegradable materials can also be considered, which can preferably be manufactured on the basis of renewable or petrochemical raw materials or of combinations of both.

At the point of demolding 27 (cf. FIG. 1), in which the fastener part is demolded from the mold cavities 12 of the screen 11, the fastener part is still in a partially plastic state and not yet fully cured. The underhooking possibilities 21 still remain briefly in the cavity 15 of the respective mold cavity 12 (see FIG. 2), so that a longitudinal pulling motion is initiated via the stem part 17 onto the lower further side 22 of the substrate part 10 with the result that trough-like further depressions 23 are drawn inwards into the bottom of the substrate part 10. Then, after demolding, the elasticity of the plastic material causes a resetting motion and the fastener part having its respective fastener element finally assume the shape shown in FIG. 3.

Another way of introducing the further crater-like or dent-like depressions 23 is to provide either the pressure roller 3 and/or a demolding roller 28 (see FIG. 1) with projections (not shown) attached to the outer circumference, wherein said projections match the contour of the respective further crater-like depression 23 to be introduced and are then stamped onto the rear of the substrate part 10 via the rollers 3, 28. In this way, the further respective crater-like depression 23 can also be made in the substrate part 10 in a position other than in extension of the stem part 17. Such impressed depressions can also be combined with the further crater-like depressions 23, such as those produced during the described extraction of the fastener part from the mold cavities of the molding roller 5. In an embodiment not shown in more detail, it is also possible to additionally or alternatively introduce such depressions on the rear of the substrate part 10 by means of a nozzle bar, wherein the depressions are impressed into the further side 22 of the substrate part 10 by means of a pressure medium (air, water) by jet-like application. Furthermore, it is possible, but likewise not shown, to produce the respective further crater-like depression 23 in the substrate part 10 by means of an etching or other removal process.

1. A fastener part consisting of at least one planar substrate part (10), on one side of which a plurality of mushroom-head-like fastener elements are arranged, each of which, as an integral part of the substrate part (10), has a solid stem part (17) formed in the manner of a rotational hyperboloid and extending along a longitudinal axis, wherein to the free end of said stem part (17) a head part (16) adjoins, the edge regions of which form hooking possibilities and project at least partially beyond the stem part (17), and wherein said head part (16) has a crater-like depression (20) on its upper side, characterized in that a plurality of further crater-like depressions (23) is incorporated into the further side (22) of the substrate part (10), opposite to the fastener elements, in that both crater-like depressions (20, 23) of at least some of the fastener elements extend concentrically or mainly concentrically to the longitudinal axis of the respective assigned stem part (17), and in that the respective further crater-like depression (23) has a maximum crater depth ranging between 30 to 60%, preferably 50%, of the thickness of the substrate part (10).

2. The fastener part according to claim 1, characterized in that the respective further crater-like depression (23), starting from the plane further side (22) of the substrate part (10), extends continuously from there without protrusion to the crater base (24).

3. The fastener part according to claim 1, characterized in that the respective further crater-like depression (23), as viewed idealized in a longitudinal cross section, transitions starting from the further side (22) of the substrate part (10) from a convex into a concave course of curvature in the direction of the crater base (24).

4. The fastener part according to claim 1, characterized in that the concave course of curvature is less strongly bent than the convex course.

5. The fastener part according to claim 1, characterized in that the respective further crater-like depression (23), viewed in a longitudinal direction (25) of the substrate part (10) corresponding to the direction of manufacture, in turn, viewed in longitudinal cross section runs off more flatly on one side towards the further side (22) of the substrate part (10) than on the opposite cross-sectional side.

6. The fastener part according to claim 1, characterized in that a further crater-like depression (23) is provided assigned to every fastener element and that all fastener elements are of identical design, as are all further crater-like depressions (23) with respect to one another.

7. The fastener part according to claim 1, characterized in that the respective stem part (17) of a fastener element at least at its foot-sided transition point (18) towards the substrate part (10) forms the uniformly extending rotational body, wherein said transition point (18) has a smaller curvature than the transition of the stem part (17) to the head-sided widening (16) having the hooking points (21) of the fastener element, and in that the course of curvature at every location of the adjacent and opposite further crater-like depressions (23) has a smaller curvature than the curvature relating to the head-sided course of curvature of the stem part (17).

8. The fastener part according to claim 1, characterized in that the largest diameter of the further crater-like depression (23) at the point of expiring to the further side (22) of the substrate part (10) is larger than the diameter of the stem part (17) at any point between its foot end (18) and its head end (16), preferably larger than the extension of the head part (16) at its widest point.

9. The fastener part according to claim 1, characterized in that an adhesive agent is introduced into the further crater-like depression (23).
